(19) United States
(12) Patent Application Publication
(10) Pub. No.: US 2017/0225927 A1
(43) Pub. Date: Aug. 10, 2017

(54) ELEVATOR SYSTEM

(71) Applicants: ThyssenKrupp Elevator AG, Essen (DE); ThyssenKrupp AG, Essen (DE)

(72) Inventors: Michael Kirsch, Kirchheim unter Teck (DE); Philippe Gainche, Großbettlingen (DE); Friedrich Löser, Riemerling (DE); Christoph Pawelski, Dresden (DE)

(73) Assignees: ThyssenKrupp Elevator AG, Essen (DE); ThyssenKrupp AG, Essen (DE)

(21) Appl. No.: 15/514,772

(22) PCT Filed: Aug. 13, 2015
(86) PCT No.: PCT/EP2015/068655

§ 371 Date: Mar. 27, 2017

(30) Foreign Application Priority Data
Sep. 30, 2014 (DE) 10 2014 219 862.3

(51) Int. Cl. B66B 11/04; B66B 9/00

(52) U.S. Cl. CPC B66B 11/0407; B66B 9/00

(57) ABSTRACT

An elevator system may include an elevator car that can be moved in an elevator shaft. The elevator car may comprise a chassis element. A rail, which in some cases is arranged as a guide rail, may be arranged in the elevator shaft. The elevator system may further comprise a linear motor with a primary part and a secondary part. The primary part of the linear motor may be arranged on the rail. The secondary part of the linear motor may be arranged on the chassis element, and the secondary part may at least partially enclose the primary part of the linear motor.

The present invention relates to an elevator system having an elevator car which can be moved in an elevator shaft, wherein the elevator car comprises a chassis element, wherein the elevator car comprises a chassis element, wherein at least one rail is arranged in the elevator shaft, and the elevator system comprises at least one linear motor, with, in each case, a primary part and, in each case, a secondary part.

### PRIOR ART

Linear motors are used to generate linear movements. Linear motors can be conceived of conceptually as a rotational motor which is unwound in a plane. A linear motor comprises a primary part and a secondary part. Such a primary part is comparable with a stator of a rotational motor and can be embodied, for example, as a coil through which a current flows. Such a secondary part or reaction part is comparable with a rotor of a rotational motor and can be embodied, for example, as a magnet, for example a permanent magnet or an electromagnet.

Either the primary part or the secondary part is embodied as a stationary element. The other element of the linear drive is embodied in a movable fashion and can be moved along the stationary element. In the case of a longitudinal-stator linear drive the primary part is embodied in a stationary fashion.

Linear drives can also be used as drives for elevator systems for moving elevator cars in an elevator shaft. For example, the elevator car can in such cases be connected to a counter weight via a supporting cable and via a roller structure. A movable element of the linear drive is arranged on the counter weight, and a corresponding stationary element of the linear drive is arranged in the elevator shaft.

However, such elevator systems have the same disadvantages as elevator systems in which an elevator car can be moved in an elevator shaft by means of conventional traction-sheave drives. Such elevator cars, which are moved by means of supporting cables and which are supported on supporting cables reach their structural limits in the case of supporting cable lengths of approximately 500 m. Supporting cables of such lengths can be subject to oscillations or movements, during which they strike against the elevator shaft or against the building, which can cause problems for the statics of the building. These disadvantages can be overcome by using cableless elevator systems with a linear drive.

A design which is simple, and, in particular also as weight-saving as possible, of an elevator system which is operated with a linear drive is therefore desirable.

### DISCLOSURE OF THE INVENTION

According to the invention, an elevator system and a drive for an elevator system having the features of the independent patent claims are proposed. Advantageous refinements are the subject matter of the dependent claims and of the following description.

An elevator system according to the invention has an elevator car which can move in an elevator shaft. At least one rail (in particular a vertically extending rail) is arranged in the elevator shaft. The elevator car comprises a chassis or a chassis element. In particular, the elevator car comprises a cabin on which the chassis element is arranged.

A drive according to the invention for moving the elevator car in the elevator shaft is embodied as a linear motor. The elevator system comprises at least one such linear motor. Such a linear motor comprises a primary part and a secondary part. This primary part corresponds, in particular, to a stator of a rotational motor. This secondary part or reaction part corresponds, in particular, to a rotor of a rotational motor.

The primary part of the at least one linear motor is arranged on the at least one rail, and the secondary part of the at least one linear motor is arranged on the chassis element. The term “arranged” is understood in this context, on the one hand, to mean that the primary part and the rail or the secondary part and the chassis element can be different elements. The primary part or the secondary part can in this case be structurally mounted on or attached to the rail or the chassis element. On the other hand, the term “arranged” is also to be understood as meaning that the primary part and rail or the secondary part and chassis element are respectively embodied as a single, non-separable element. The primary part and the rail (or the secondary part and the chassis element) are embodied in this case as a single-piece structure. In this way, in particular, the secondary part of the linear motor can be integrated to a maximum extent into the chassis element.

In particular different secondary parts of a plurality of different linear motors can expediently be arranged on the chassis element. Different primary parts of different linear motors can each be arranged on different rails of the elevator system. However, different primary parts of different linear motors can also be arranged on one rail.

It is to be noted that the following description is directed, in particular, to “a” or to “the” linear motor and to “a” or to “the” rail. The following statements apply in an analogous fashion to a plurality of such linear motors and a plurality of rails.

The secondary part of the at least one linear motor encloses or borders or surrounds or encompasses the primary part of the at least one linear motor, at least partially. Individual elements of the secondary part are arranged, in particular, on the chassis element in such a way that they are arranged around corresponding elements of the primary part.

The linear motor is embodied, in particular, as a longitudinal-stator linear motor. The primary part and secondary part interact with one another, as a result of which the elevator car is moved. In particular, the primary part comprises at least one coil (through which current flows), in particular at least one copper coil. In addition, the secondary part comprises, in particular, at least one magnet, for example at least one permanent magnet and/or at least one electromagnet. In particular the movement of the elevator car in the elevator shaft is controlled by the flow of current through such a coil through which current flows.

### ADVANTAGES OF THE INVENTION

The elements of the linear motor are arranged according to the invention on the rail and on the elevator car or on the actual chassis element thereof. The rail and the chassis element are present, in particular, in any case in the elevator shaft and are provided for moving the elevator car. According to the invention, the rail and the chassis element additionally function as securing means for the linear motor.

In particular, the chassis element functions as a suspension means for the elevator car. The elevator car is fabricated, in particular, with a lightweight design. The loads which act on the suspension means of the elevator car can therefore be kept as small as possible. The elevator car comprises, in particular a cabin. In addition, the chassis element is arranged, in particular, on the cabin.

In addition, in particular a safety device or safety-catch device for protecting the elevator car against falling is arranged on the chassis element. This safety device is triggered, for example, by a speed limiter as soon as the speed of the elevator car exceeds a limiting value. Such a speed limiter is embodied, in particular, as an electronic system. The speed limiter evaluates, in particular, sensor data in order to determine the speed of the elevator car. If the speed of the elevator car exceeds the limiting value, the speed limiter activates actuators in order to trigger the safety device or the safety-catch device.

According to the invention, it is necessary to arrange elements of the linear motor on elements of the elevator system other than the rail and the elevator car or the chassis element. The elevator system is embodied, in particular as an elevator system without a machine room. Large, heavy and expensive drives, for example traction-sheave drives, can be avoided by means of the invention. Required space or spatial requirements and weight loading of the drive and of the entire elevator system can be reduced.

The elevator system is embodied, in particular without counter weights and, in addition, in particular without supporting cables. These elements of an elevator system can be avoided by means of the invention. The elevator car is accordingly moved, in particular in a cableless fashion, that is to say without supporting cables. This cableless movement of the elevator car provides considerable advantages over elevator cars which are moved by means of supporting cables. Such elevator cars which are moved by means of supporting cable or which are suspended on supporting cables, come up against structural limits in the case of supporting cable lengths of approximately 500 m: supporting cables of such lengths can be subject to oscillations or movements, during which they strike against the elevator shaft or against the building, which can lead to problems for the statics of the building. These disadvantages can be overcome by using a linear motor and by means of a cableless movement of the elevator car. The elevator car can therefore also be moved without difficulty over building heights of over 500 m.

Already existing conventional elevator systems can be retrofitted in a simple, uncomplicated way. The rail and chassis element are, in particular, present in any case in a conventional elevator shaft. The secondary part can easily be arranged on or attached to the chassis element, and the primary part can easily be arranged on or attached to the rail. New, not already existing elevator systems can easily be constructed and manufactured according to the invention. Rails with an integrated primary part and chassis elements with an integrated secondary part can be manufactured as single-piece structures by means of expedient fabrication methods.

According to one advantageous refinement of the invention, the secondary part of the at least one linear motor comprises a U-shaped supporting element, for example a U-profile. In particular the secondary part is attached to the chassis element by means of this U-shaped supporting element. This supporting element comprises, in particular, two limbs which are arranged parallel to one another, and a supporting structure which is arranged perpendicularly with respect to these limbs. In particular, the secondary part is attached to the chassis element by means of this supporting structure or connected in one piece to said chassis element.

By means of this U-shape of the supporting element, the secondary part can at least partially enclose the primary part. The primary part is arranged, in particular on the rail in such a way that it projects at least partially into this U-shaped supporting element. In addition, in particular the primary part is arranged on the rail in such a way that it is arranged at least partially between the two limbs which are arranged parallel to one another.

The secondary part preferably comprises two magnet elements which are arranged parallel to one another. These magnet elements are, in particular, arranged on the secondary part in such a way that each run next to the primary part. The primary part is therefore, in particular, enclosed or surrounded at least partially by these magnet elements of the secondary part.

The two magnet elements are also preferably arranged on the U-shaped supporting element of the secondary part. In particular, each of the two magnet elements is arranged on, in each case, one of the two limbs of the supporting element which are arranged parallel to one another, in particular on the respective inner sides of the limbs.

The two magnet elements preferably each comprise at least two magnets which are arranged in the longitudinal direction of the supporting element (or in the longitudinal direction of the elevator shaft). In particular, these magnets are embodied in each case as permanent magnets and/or electromagnets. Such a magnet element is therefore, in particular, an arrangement composed of a plurality of individual magnets.

The secondary part of the at least one linear motor is advantageously constructed at least partially from aluminum and/or a fiber composite material, in particular of carbon-fiber-reinforced plastic (CFRP). In particular, the secondary part is therefore constructed from a lightweight material. The secondary part is fabricated, in particular with a lightweight design. The weight of the linear motor, in particular of the secondary part of the linear motor, can therefore be kept as low as possible. Loading which acts on the suspension system of the elevator car is kept as low as possible. In particular, the elevator car and/or the chassis element are also fabricated from such a lightweight material.

In particular, the U-shaped supporting element of the secondary part is constructed from such a lightweight material. In this case, it is expedient not to arrange the magnet elements of the secondary part directly on the supporting element but instead to arrange a ferromagnetic material (for example steel) or a layer of such a ferromagnetic material between the supporting element and the magnet element. Such a ferromagnetic material is usually required for sufficient magnetic flux. Such a ferromagnetic material, in particular steel, is usually associated with high weight loading for the elevator car. This weight loading can be kept as low as possible by virtue of the construction of the U-shaped supporting element from the lightweight material and the comparatively thin layer made of ferromagnetic material.

In particular, the secondary part, more particularly, the U-shaped supporting element, are fabricated by means of the fabrication method of extrusion. In this fabrication method, the lightweight material is pressed or drawn through a shaping opening. In this way, the U-shaped supporting element can be fabricated as a U-profile to an expedient length in a cost-effective and simple way. More particularly, the chassis element is fabricated with an integrated secondary part or with an integrated U-shaped supporting element by means of the fabrication method of extrusion.

The elevator system preferably comprises at least two linear motors with, in each case, a primary part and, in each case, a secondary part. The secondary parts of two linear motors are preferably arranged (directly) one next to the other. In particular, the U-shaped supporting elements of these secondary parts which are arranged one next to the other are arranged (directly) one next to the other.

In particular, two U-shaped supporting elements which are arranged directly one next to the other, of two secondary parts, form a W-shaped (or double U-shaped) element. In particular, a bending torque can be absorbed particularly well by such a W-shaped element.

The primary parts of these two linear motors which are arranged (directly) one next to the other are, in particular, arranged one next to the other on a rail. Alternatively, these two primary parts can also be arranged on two different rails which are arranged one next to the other.

The secondary parts which are arranged one next to the other advantageously have a common central web. In particular, the two U-shaped supporting elements which are arranged directly one next to the other and which form a W-shaped element are connected to one another via such a common central web or a common connecting element. Such a common central web is embodied, in particular, as a common limb of the two U-shaped supporting elements which are arranged one next to the other.

Such a central web is constructed, in particular, from ferromagnetic material (for example steel). In particular in each case a magnet element of the two secondary parts which are arranged one next to the other, of the two linear motors is arranged on the two side faces of the central web. This ferromagnetic material is used, in particular, for the magnetic flux of these two magnet elements. There can therefore be a saving in ferromagnetic material and weight loading can be kept as low as possible.

According to a first preferred refinement of the invention, the chassis element is embodied as a frame element which at least partially borders or surrounds the cab of the elevator car. The frame element does not necessarily have to be closed but rather can, in particular, also contain openings, for example on an upper side and/or underside of the elevator car. The frame element can also be embodied in a closed fashion and can completely border or surround the cabin. In particular, the chassis element is embodied as a safety frame of the elevator car.

The secondary part of the at least one linear motor is advantageously arranged on a vertical side part on a vertically extending side part of the frame element. This vertical side part of the frame element is arranged, in particular, on a vertical side face of the cabin. In this context, those faces of the cabin which extend vertically are to be understood as vertical side faces, said faces adjoining a front side of the cabin, that is to say a face of the cab with a cab door. The secondary part of the linear motor is accordingly arranged, in particular, on one of the vertical side faces of the cab or of the elevator car.

The elevator system preferably comprises two linear motors with, in each case, a primary part and, in each case, a secondary part. The secondary parts of the two linear motors are preferably arranged on opposite vertical side parts of the frame element. Therefore, in particular in each case a secondary part of one of the two linear motors is arranged on each of the two vertical side faces of the cabin or of the elevator car. In particular, in this case two rails are arranged in the elevator shaft. In particular, in each case a primary part of one of the two linear motors is arranged on each of these two rails.

The elevator system can also comprise more than two linear motors. In this case, in each case a plurality of secondary parts can also be arranged on the vertical side parts of the frame element. In particular, secondary parts can also be arranged directly one next to the other on the vertical side parts and can form a W-shaped element according to the above description.

According to a second preferred refinement of the invention the chassis element is embodied as a backpack-type element which is arranged on a rear side of the cab. In particular a vertically extending face of the cabin which lies opposite the front side of the cabin, that is to say the face of the cabin with the cabin door, is to be understood as the rear side of the cabin. The chassis element functions here, in particular, as a suspension means of the elevator car, and the suspension means of the elevator car is embodied in this case, in particular, as a backpack-type suspension.

The elevator system preferably comprises at least two linear motors with, in each case, a primary part and, in each case, a secondary part. The secondary parts of the at least two linear motors are preferably arranged one next to the other on the backpack element. In particular, in this case a rail is arranged in the elevator shaft. In particular the primary parts of the at least two linear motors are arranged one next to the other on this rail. Alternatively, a plurality of rails can also be arranged one next to the other. In particular, in each case a primary part of one of the at least two linear motors can be arranged on each of this plurality of rails.

In particular, in this case the U-shaped supporting elements of the secondary parts of the at least two linear motors are arranged one next to the other on the backpack-type element. In particular, two such U-shaped supporting elements of two secondary parts of two linear motors form a W-shaped element according to the above description.

Such a chassis element which is embodied as a frame element or backpack-type element is usually present in any case in the elevator system. Additional elements therefore do not have to be installed for the linear motor in the elevator system in which the linear motor is arranged.

The at least one rail is advantageously embodied as at least one guide rail. In particular, corresponding guide rollers are arranged on the elevator car. Such guide rails are usually present in any case in the elevator system and are arranged in the direct vicinity of the chassis element. It is therefore particularly appropriate to arrange the primary part of the linear motor on a guide rail. The rails therefore function both as a drive and as a guide for the elevator car. Additional elements therefore do not have to be installed for the linear motor in the elevator system in which the linear motor is arranged.

At this point it is to be noted that in principle it is also conceivable to embody the linear motor as a short-stator linear motor. In this case, the primary part, in particular a coil through which current flows, is arranged on the chassis element, and the secondary part is arranged on the rail.

Further advantages and refinements of the invention can be found in the description and the appended drawing.

Of course, the features which are mentioned above and which are still to be explained below can be used not only in the respectively specified combination but also in other combinations or alone without departing from the scope of the present invention.

The invention is illustrated schematically in the drawing by means of an exemplary embodiment and is described below in detail with reference to the drawing.

### DESCRIPTION OF THE FIGURES

FIG. 1 is a schematic, perspective view of a preferred refinement of an elevator system according to the invention,

FIG. 2 is a perspective view of a chassis element of an elevator car according to a preferred refinement of an elevator system according to the invention,

FIG. 3 is a schematic, perspective view of a secondary element of a preferred refinement of a drive according to the invention,

FIG. 4 is a schematic, plan view of a preferred refinement of an elevator system according to the invention,

FIG. 5 is a schematic, perspective view of a preferred refinement of an elevator system according to the invention,

FIG. 6 is a schematic, plan view of a preferred refinement of an elevator system according to the invention, and

FIG. 7 is a schematic, plan view of a preferred refinement of an elevator system according to the invention.

Identical reference symbols in the figures describe structurally identical elements and are not explained separately each time.

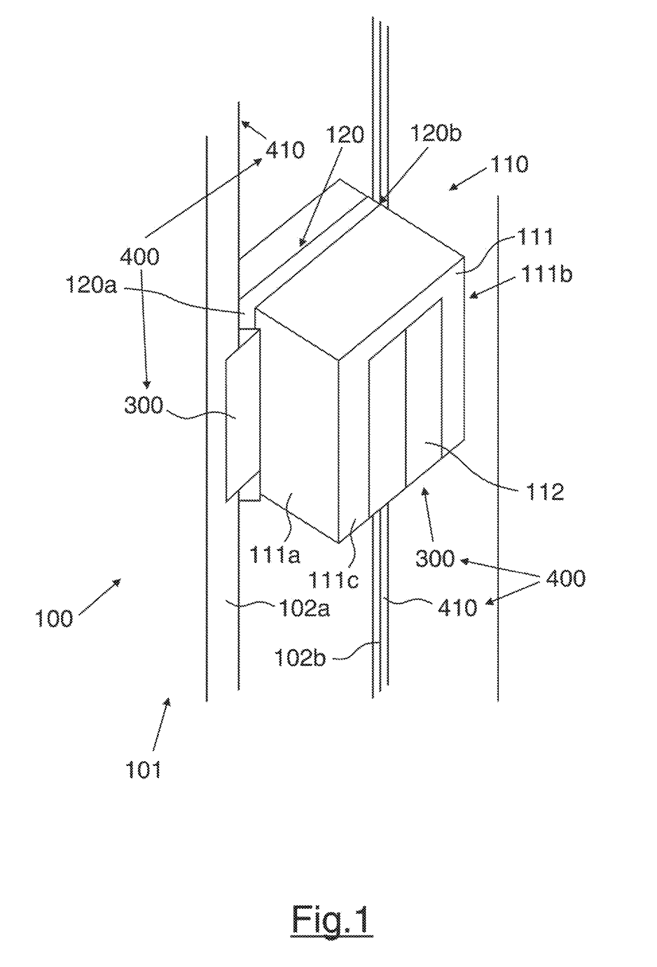

FIG. 1 is a schematic illustration of a preferred refinement of an elevator system according to the invention and is denoted by 100. An elevator car 110 can be moved in an elevator shaft 101. The elevator car 110 comprises a cabin 111 and a chassis element 120.

FIG. 1 is a schematic illustration of the elevator system 100 with a first preferred refinement 120 of such a chassis element. The chassis element 120 according to FIG. 1 is embodied as a frame element or a safety frame of the elevator car 110. In this example, the frame element 120 borders the cabin 111 of the elevator car 110.

A first vertical side part 120a of the frame element 120 is arranged on a first vertical side face 111a of the cabin 111. A second vertical side part 120b of the frame element 120 is arranged on a second vertical side face 111b of the cabin 111. These left-hand and right-hand vertical side faces 111a and 111b adjoin a front side 111c of the cabin 111, that is to say a face of the cabin with a cabin door 112.

Furthermore, a first rail 102a and a second rail 102b are arranged in the elevator shaft 101. These first and second rails 102a and 102b are embodied as guide rails for the elevator car 110. The first vertical side part 120a of the frame element 120 is arranged in the direct vicinity of the first rail 102a, and the second vertical side part 120b of the frame element 120 is arranged in the direct vicinity of the second rail 102b.

A preferred refinement of a drive according to the invention is provided for moving the elevator car 110 in the elevator shaft 101. The drive is embodied as a linear motor, in particular as a longitudinal-stator linear motor.

In the example in FIG. 1, the elevator system 100 comprises two such linear motors 400. A primary part 410 of a first linear motor 400 is arranged on the first rail 102a. A secondary part 300 of the first linear motor 400 is arranged on the first side part 120a of the frame element 120. A primary part 410 of the second linear motor 400 is arranged on the second rail 102b. A secondary part 300 of the second linear motor 400 is arranged on the second side part 120a of the frame element 120.

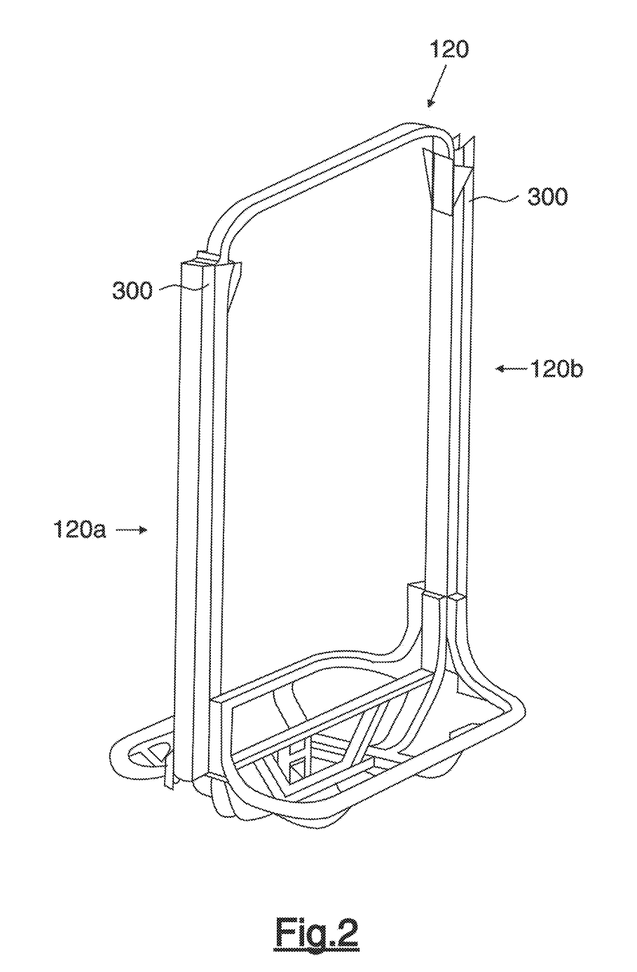

FIG. 2 is a schematic illustration of a perspective view of the chassis element 120 embodied as a frame element, according to FIG. 1.

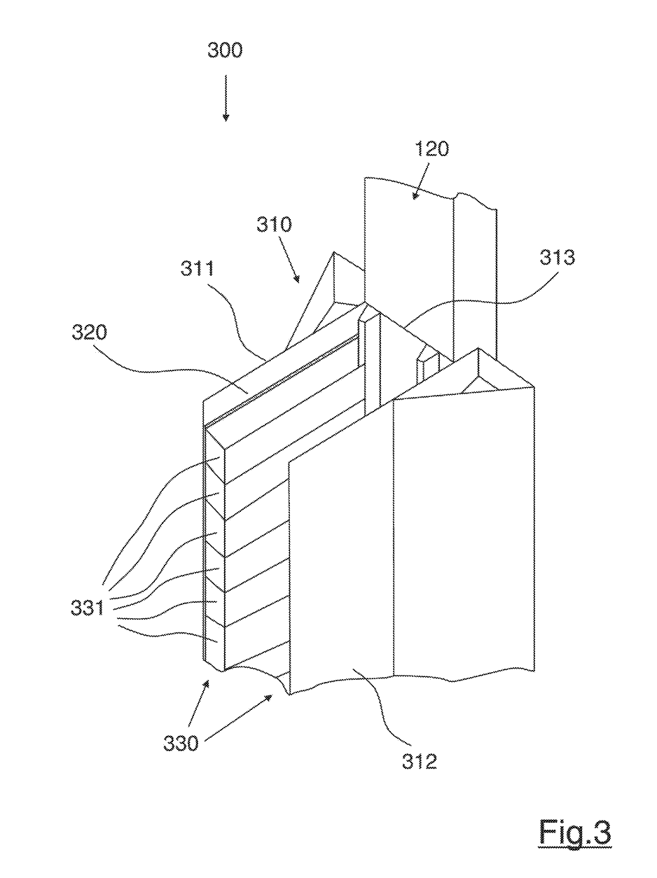

FIG. 3 is a schematic illustration of a perspective view of the secondary part 300 of a preferred refinement of a drive 400 according to the invention according to FIG. 1.

The secondary part 300 comprises a U-shaped supporting element 310. The U-shaped supporting element 310 comprises two limbs 311 and 312 which are arranged parallel to one another, and a supporting structure 313 is which is arranged perpendicularly with respect to these limbs. The secondary part 310 can be attached to the chassis element 120 of the elevator car 110 by means of this supporting structure 313.

This U-shaped supporting element 310 is constructed, in particular from a carbon-fiber-reinforced plastic (CFRP). Such a U-shaped supporting element 310 can be fabricated as a U-profile, in particular by means of the fabrication method of extrusion.

In each case a layer 320 made of a ferromagnetic material, for example steel, is applied to the inner sides of the two limbs 311 and 312 which are arranged parallel to one another.

On this layer 320, a magnet element 330 is arranged on each of the limbs 311 and 312. The magnet elements 330 are also arranged parallel to one another. Each magnet element 330 comprises in each case a plurality of magnets 331, for example permanent magnets (only shown in detail for limb 311) which are arranged one on top of the other in the longitudinal direction of the supporting element 310.

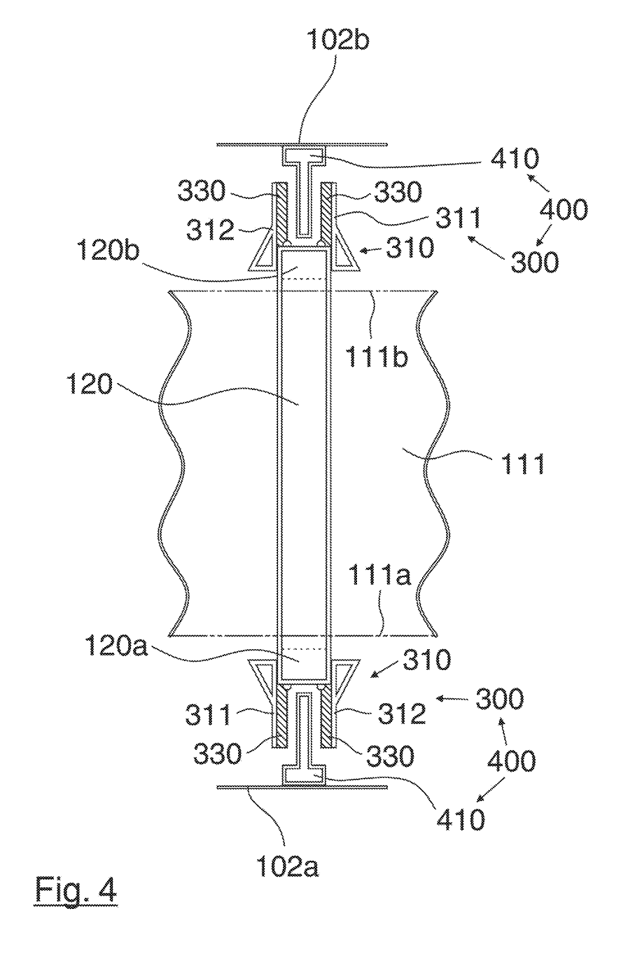

FIG. 4 illustrates the elevator system 100 according to FIG. 1 in a schematic, plan view.

As is also apparent in FIG. 4, the primary part 410 of one of the linear motors 400 is arranged in each case on the first rail 102a and on the second rail 102b. The primary parts 410 are each embodied as copper coils.

The magnet elements 330 of the respective secondary parts 300 of the linear motors are arranged laterally next to these primary parts 410. The secondary part 300 of the linear motor 400 therefore encloses the respective primary part 410 of the respective linear motor 400.

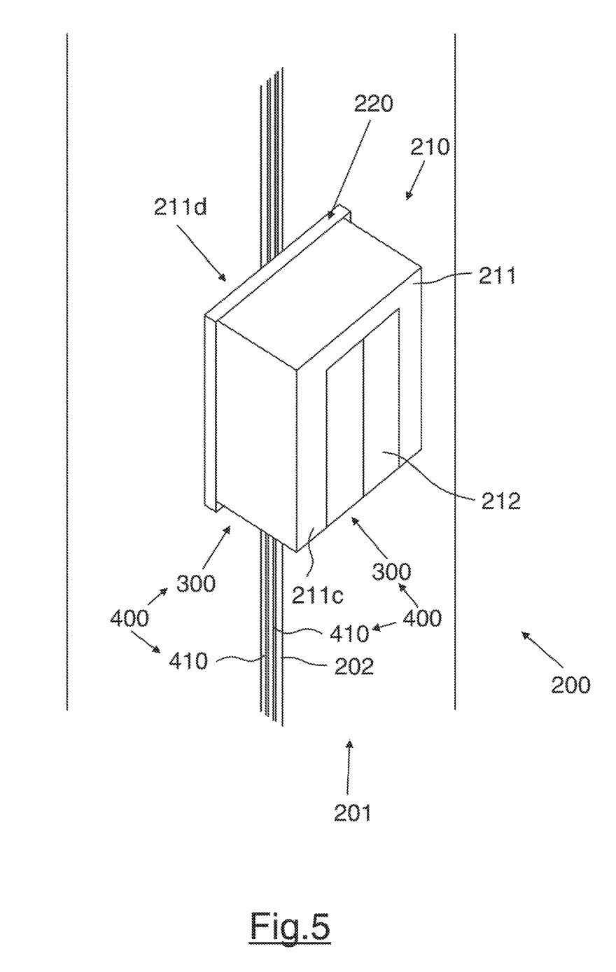

A further preferred refinement of an elevator system according to the invention is illustrated schematically in FIG. 5, in a way which is analogous to FIG. 1, and denoted by 200. An elevator car 210 can be moved in an elevator shaft 201. The elevator car 210 comprises a cabin 211 and a chassis element 220.

FIG. 5 is a schematic illustration of the elevator system 200 with a second preferred refinement 220 of such a chassis element. The chassis element 220 is embodied as a backpack-type element.

The backpack-type element 220 is arranged on a rear side 211d of the cabin 211. The rear side 211d of the cabin is a vertically extending face of the cabin 211 which lies opposite a front side 211c of the cabin, this is to say a face of the cabin 211 with a cabin door 212.

Furthermore, a rail 202 is arranged in the elevator shaft 201. This rail 202 is embodied as guide rails for the elevator car 210. The backpack-type element 220 is arranged in the direct vicinity of the rail 202.

A preferred refinement of a linear motor according to the invention is provided for moving the elevator car 210 in the elevator shaft 201, in a way analogous to FIG. 1 or FIG. 3.

In the example in FIG. 5, the elevator system 200 also comprises two such linear motors 400. A primary part 410 of a first linear motor 400 and a primary part 410 of a second linear motor 400 are arranged one next to the other on the rail 202. A secondary part 300 of the first linear motor 400 and a secondary part 300 of the second linear motor 400 are arranged one next to the other on the backpack-type element 220.

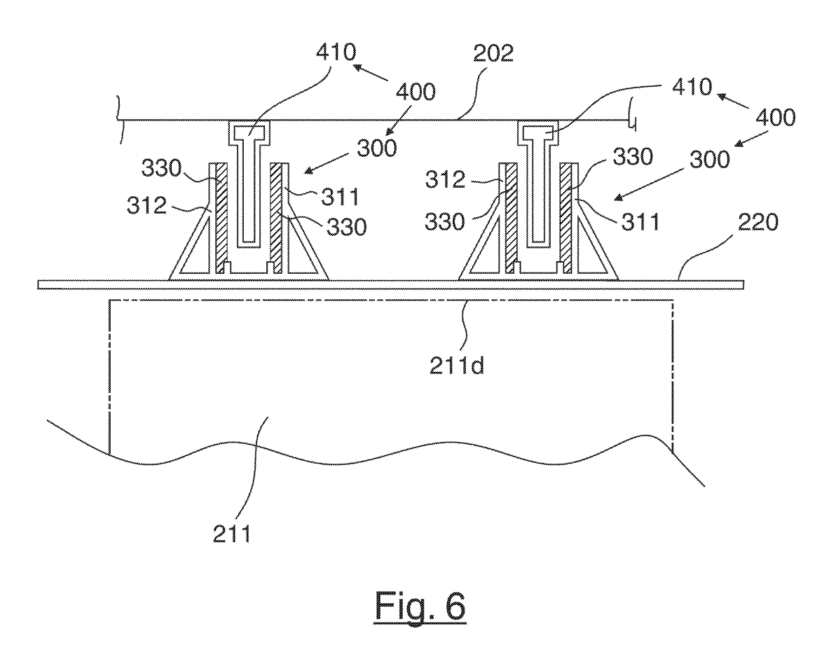

FIG. 6 is a schematic illustration of a plan view of the elevator system 200 according to FIG. 5. As is apparent from FIG. 6, the primary parts 410 of the first and second linear motors 400 are arranged one next to the other spaced apart by a certain distance on the rail 202, and the secondary parts 300 of the first and second linear motors 400 are arranged one next to the other spaced apart by a certain distance on the backpack-type element 220.

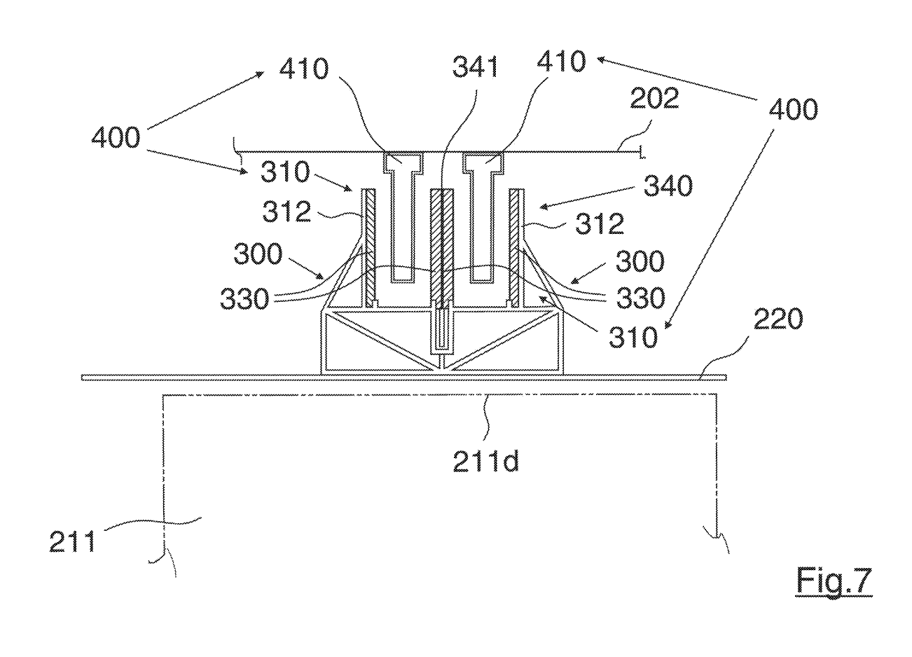

FIG. 7 is a schematic illustration of a plan view of the elevator system 200 according to FIG. 5, in a way analogous to FIG. 6. In this example, according to one preferred refinement of the invention the two secondary parts 300 of the two linear motors 400 are arranged directly one next to the other on the backpack-type element 220.

The two U-shaped supporting elements 310 of the two linear motors 400 form here a W-shaped or double U-shaped element 340. The limbs, which adjoin one another, of the two U-shaped supporting elements 310 of the two linear motors 400 are embodied in this example as a common limb or as a common central web 341. In particular this common central web 341 is fabricated from ferromagnetic material, for example steel.

### LIST OF REFERENCE NUMBERS

100 Elevator system
101 Elevator shaft
102a First rail, guide rail
102b Second rail, guide rail
110 Elevator car
111 Cabin
111a First vertical side face
111b Second vertical side face
111c Front side
112 Cabin door
120 Chassis element, frame element
120a First vertical side part
120b Second vertical side part
200 Elevator system
201 Elevator shaft
210 Elevator car
211 Cabin
211c Front side
211d Rear side
212 Cabin door
220 Chassis element, backpack-type element
300 Secondary part of the linear motor
310 U-shaped supporting element
311 Limb
312 Limb
313 Supporting structure
320 Layer made of ferromagnetic material
330 Magnet element
331 Magnet, permanent magnet
340 W-shaped element
341 Common central web
400 Linear motor
410 Primary part of the linear motor

1.-15. (canceled)

16. An elevator system comprising:
a rail disposed in an elevator shaft;
an elevator car that is movable in the elevator shaft and comprises a chassis element; and
a linear motor comprising a primary part that is disposed on the rail, the linear motor further comprising a secondary part that is disposed on the chassis element, wherein the secondary part at least partially encloses the primary part.

17. The elevator system of claim 16 wherein the secondary part comprises a U-shaped supporting element.

18. The elevator system of claim 16 wherein the secondary part comprises two magnet elements that are arranged parallel to one another.

19. The elevator system of claim 18 wherein the secondary part comprises a U-shaped supporting element, wherein the two magnet elements are disposed on limbs of the U-shaped supporting element.

20. The elevator system of claim 18 wherein the secondary part comprises a U-shaped supporting element, wherein each of the two magnet elements comprises at least two magnets that are disposed in a longitudinal direction of the U-shaped supporting element.

21. The elevator system of claim 16 wherein the linear motor is a first linear motor, the elevator system further comprising a second linear motor that includes a primary part and a secondary part, wherein the secondary parts of the first and second linear motors are disposed adjacent to one another.

22. The elevator system of claim 21 wherein the secondary parts of the first and second linear motors have a common central web.

23. The elevator system of claim 16 wherein the chassis element is configured as a frame element that at least partially surrounds a cabin of the elevator car.

24. The elevator system of claim 23 wherein the secondary part of the linear motor is disposed on a vertical side part of the frame element.

25. The elevator system of claim 23 wherein the linear motor is a first linear motor, the elevator system further comprising a second linear motor that includes a primary part and a secondary part, wherein the secondary parts of the first and second linear motors are disposed on opposite vertical side parts of the frame element.

26. The elevator system of claim 16 wherein the chassis element is configured as a backpack-type element that is disposed at least partially on a rear side of a cabin of the elevator car.

27. The elevator system of claim 26 wherein the linear motor is a first linear motor, the elevator system further comprising a second linear motor that includes a primary part and a secondary part, wherein the secondary parts of the first and second linear motors are disposed adjacent to one another on the backpack-type element.

28. The elevator system of claim 16 wherein the secondary part of the linear motor comprises at least one of aluminum or a fiber composite material.

29. The elevator system of claim 28 wherein the fiber composite material is carbon-fiber-reinforced plastic.

30. The elevator system of claim 16 wherein the rail is configured as a guide rail.

31. A drive for an elevator system for moving an elevator car in an elevator shaft, the drive comprising a linear motor that includes a primary part and a secondary part, wherein the primary part is disposable on a rail in the elevator shaft, wherein the secondary part is disposable on a chassis element of the elevator car, wherein the secondary part of the linear motor at least partially encloses the primary part.

32. An elevator system comprising a drive for an elevator system for moving an elevator car in an elevator shaft, wherein the drive comprises a linear motor that includes a primary part and a secondary part, wherein the primary part is disposable on a rail in the elevator shaft, wherein the secondary part is disposable on a chassis element of the elevator car, wherein the secondary part of the linear motor at least partially encloses the primary part.
